(19) United States
(12) Patent Application Publication
(10) Pub. No.: US 2002/0121861 A1
(43) Pub. Date: Sep. 5, 2002

(54) Plasma display panel

(76) Inventors: Akira Katou, Mito (JP); Hiroshi Kajiyama, Kodaira (JP); Kazuo Uetani, Nishinomiya (JP); Ken-ichi Onisawa, Hitachinaka (JP); Tetsuro Minemura, Hitachiota (JP); Yasushi Ihara, Takarazuka (JP); Shiro Takigawa, Kyoto (JP); Kouichi Nose, Osaka (JP); Isao Tokomoto, Ikeda (JP); Yasuhiro Koizumi, Nishinomiya (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/931,876

(22) Filed: Aug. 20, 2001

(30) Foreign Application Priority Data
Mar. 1, 2001 (JP) 2001-056996

(51) Int. Cl. H01J 17/49

(52) U.S. Cl. 313/587

(57) ABSTRACT

Provided in a plasma display panel having a protective film for electrodes improved in secondary electron emission characteristics.

A plasma display panel which has a front substrate having sustaining electrodes wired thereon and a rear substrate having address electrodes wired thereon and displays an image by means of electric discharge that occurs in a minute discharge space formed in a gap between the two substrates and which has a protective film comprising at least one metal oxide which covers a dielectric layer provided to the front substrate, the protective film being constituted essentially of a material which undergoes an elimination of a major part of moisture and carbon dioxide adsorbed thereonto at a temperature of 350° C. or less.

### FIELD OF THE INVENTION

The present invention relates to a plasma display panel (hereinafter referred to as PDP) used as a display device.

### BACKGROUND OF THE INVENTION

A PDP is a display device which comprises two glass substrates and a large number of enclosed minute discharge spaces provided in a gap between the substrates. In a PDP of a matrix display system, for example, a large number of electrodes are arranged in the form of a grid, and discharge cells present at the intersections of respective electrodes are made to emit light selectively, thereby to display an image. In an AC-type PDP of a typical surface discharge type, sustaining electrodes of the front plate are covered with a dielectric layer and further a protective film is formed on the dielectric layer.

### SUMMARY OF THE INVENTION

The above-mentioned dielectric layer is provided for the purpose of accumulating electric charges produced by an application of voltage to the electrode; the protective film is provided for preventing a damage of the dielectric layer caused by a collision of ions present in discharging gas and for lowering a firing voltage by secondary electron emission.

The protective film hitherto mainly used is a magnesium oxide film of about several hundred nm thickness formed by a thin film process, such as vapor deposition. The magnesium oxide film usually has moisture, carbon dioxide, oxygen, hydrogen etc. adsorbed thereto, and it is apprehended that the adsorbed substances influence on initial discharge characteristics and further that the substances are emitted into an enclosed gas as impurity gases during the operation of PDP to affect adversely operating conditions of PDP. In particular, the adsorbed substances affect adversely secondary electron emittability which exerts a great influence on discharge voltage.

In current processes for producing PDP, a panel is evacuated before a discharge gas is enclosed. Gases which have not been completely removed and left behind in the evacuation step remain as impurity gases after a completion of the ultimate product. At this time, particularly moisture and carbon dioxide adsorbed to the protective film are difficult to eliminate and require an evacuation of a long period of time at a high temperature. Frequently, the long-time evacuation step becomes the rate-determining step in the overall production line. Furthermore, an evacuation at a high temperature may adversely affect other members of the panel and hence should be carefully restricted.

A protective film used in AC-type PDP is required to have a high secondary electron emittability which is stable also during its use.

In a PDP production process, gas components adsorbed onto the protective film, particularly moisture and carbon dioxide, are removed to activate the protective film; it is necessary that the removal can be effected with ease.

Previous protective films have a problem in that they adsorb moisture and carbon dioxide strongly and, even when subjected to vacuum heating at 350° C., hold much moisture and carbon dioxide remained therein. As the result, after a completion of panel manufacture, an effective secondary electron emittability is adversely affected, and discharge characteristics tend to be poor. Moreover, since impurity gases are emitted from the protective film at the time of use, there was a defect that it took a great deal of time for the discharge characteristics to become stable. As a result, it was necessary to take corrective measures such as increasing a heating temperature or lengthening an evacuation time, which lead to an increase of production cost.

In view of the situations, the object of the present invention is to provide a PDP provided with a protective film for PDP electrodes which film readily eliminates adsorbed moisture and carbon dioxide and has a high secondary electron emittability that shows a good stability.

The essentials of the present invention for achieving the above-mentioned object are as follows.

A plasma display panel which has a front substrate (plate) having sustaining electrodes wired (distributed) thereon and a rear substrate (plate) having address electrodes wired thereon and displays an image by means of electric discharge which occurs in a minute discharge space formed in a gap between the two substrates and which has a protective film comprising at least one metal oxide which covers a dielectric layer provided to the front substrate, the protective film being constituted essentially of a material which undergoes an elimination of a major part of moisture and carbon dioxide adsorbed thereto at a temperature of 350° C. or less.

For a PDP, a protective film is used which has a characteristic of permitting an easy elimination of moisture and carbon dioxide at a temperature of 350° C. or less. It is particularly desirable to use a protective film which has a characteristic of permitting an elimination of 90% or more of the adsorbed moisture and carbon dioxide by means of heat evacuation at 350° C. or less.

For previous protective films, oxide films comprising magnesium oxide as a main component have been used, which are formed into a film of about several hundred nm thickness by, for example, electron beam vapor deposition.

The present inventors have made extensive study on the relation between the protective film physical properties and the PDP characteristic properties. As the result, the inventors have found that a film which, in the heat evacuation step, readily permits an elimination of moisture and carbon dioxide therefrom gives, when incorporated into a panel, a low operating voltage, a small fluctuation of operating voltage during use and also an excellent stability of the voltage. The present invention has been attained on the basis of the above findings.

More specifically, in a preferred protective film, the elimination of adsorbed moisture and carbon dioxide preferably proceeds at a temperature of 350° C. or less and, as to the amount, at least 90% is desirably eliminated.

Previous protective films have been mainly formed by electron beam vapor deposition. In such films, it has been found that elimination peaks of adsorbed moisture and carbon dioxide usually show a number of elimination peaks in the range of from 100° C. to 500° C. In such cases, by the heat evacuation treatment of about 350° C. used in conventional PDP production process, moisture and carbon dioxide which have been adsorbed to the protective film cannot be removed completely and, in some cases, substantial amounts of moisture and carbon dioxide remain as adsorbed to the protective film.

Such residual impurity gases not only lower the secondary electron emittability of the protective film but are released into the discharge gas with the lapse of time to exert adverse effects on electric discharge.

The protective film for PDP electrodes of the present invention is characterized by permitting the elimination of most of the moisture and carbon dioxide by heat evacuation at a temperature of 350° C. or less and shows a high secondary electron emittability and discharge stability.

Another characteristic of the protective film for PDP electrodes of the present invention consists in that at least 90% of the adsorbed moisture can be removed by heat evacuation at 350° C. In this case, a period of time necessary for the heat evacuation is, as a guide, about 2 hours at 350° C. for ordinary panels, though it may vary depending on the size and cell structure of the panel, the capacity of the evacuation apparatus and the method of evacuation.

The protective film for PDP electrodes of the present invention can use an oxide, particularly preferable being a film comprising magnesium oxide as a main component. Though the relation between the structure of the magnesium oxide film and its characteristic property is not yet definitely clear, controlling the surface structure may be mentioned as one example of possible utilization of knowledge on such a relation.

Thus, it is desirable that a crystal orientation in a direction parallel to a substrate surface consists mainly of the (111) plane and planes exposed to the surface are mainly the (200) and (220) planes. It can be considered that such structure control yields a characteristic property of permitting an easy elimination of adsorbed moisture and carbon dioxide.

Further, for facilitating the elimination of moisture and carbon dioxide, the property of magnesium oxide can be controlled by an addition of a second component. By the addition of a suitable second component, adsorption sites for moisture and carbon dioxide can be decreased and an adsorptive power can be weakened.

The above-mentioned second component may be, for example, oxides of Ca, Sr, Ba, Zr, Al, Ti, Si, Zn, La, Ce, Y and so forth. The amount of these components to be added may be selected from respective suitable ranges for respective components.

Such films containing a suitable second component, as compared with a previous protective film comprising magnesium oxide alone, permits more easy elimination of adsorbed moisture and carbon dioxide, and the step of panel assembling can be simplified. By conducting heat evacuation at 350° C. in the panel assembling step, a plasma display panel can be obtained in which the amount of residual moisture and carbon dioxide is small, a discharge voltage is low and a stability of discharge characteristic is excellent.

### BRIEF DESCRIPTION OF THE DRAWINGS

FIG. 1 is a diagram showing the structure of a part corresponding to one picture element of an AC-type PDP.

FIG. 2 is a schematic view of a secondary electron emission coefficient measuring apparatus.

FIG. 3 is a graph showing the result of determination of the secondary electron emission characteristic.

### (DESCRIPTION OF REFERENCE NUMERALS:)

1R . . . red fluorescent material, 1G . . . green fluorescent material, 1B . . . blue fluorescent material, 2 . . . partition wall, 3 . . . address electrodes, 4 . . . rear substrate, 5 . . . protective film, 6 . . . dielectric layer, 7 . . . sustaining electrodes, 8 . . . bus electrode, 9 . . . front substrate, 10 . . . stainless steel substrate, 11 . . . protective film, 12 . . . Ne ion beam, 13 . . . secondary electron, 14 . . . collector electrode.

### DETAILED DESCRIPTION OF THE INVENTION

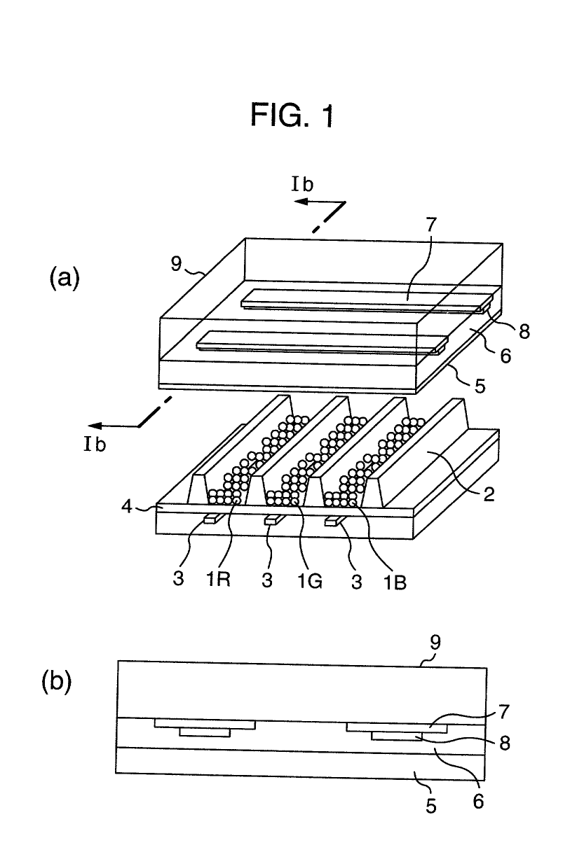

FIG. 1 is an enlarged view showing a part which constitutes one picture element of a PDP using The protective film of the present invention. FIG. 1(a) is a perspective view and FIG. 1(b) is a sectional view taken along Ib-Ib of FIG. 1(a).

In the PDP, as shown in FIG. 1(a), a front substrate 9 and a rear substrate 4 are provided so as to oppose to each other. The rear substrate 4 is provided, separated from one another by a partition wall 2 (barrier rib), with three kinds of fluorescent materials 1R, 1G and 1B for displaying one picture element.

The picture element is constructed such that one picture element can be displayed in respective colors by the three kinds of fluorescent materials 1R, 1G and 1B, respectively.

The rear substrate 4 is further provided with address electrodes 3 wired along Y axis direction. The front substrate 9 is provided with sustaining electrodes 7 wired along X axis direction such that the electrodes 7 may be perpendicular to the above-mentioned address electrodes. The sustaining electrodes 7 are provided with a bus electrode 8 wired so as to lie parallel to the electrodes 7.

One side surface of the sustaining electrodes 7 and the bus electrode 8 are covered with a dielectric layer 6. Further, a protective film 5 is provided onto a surface of the dielectric layer 6.

A rare gas of a specified pressure is enclosed as a discharge gas between the front substrate 9 and the rear substrate 4. When a predetermined voltage is applied to the address electrodes 3, sustaining electrodes 7 and bus electrode 8, the fluorescent material emits visible light by the action of ultraviolet light which goes with a plasma discharge of the above-mentioned rare gas, and visible light is radiated from the front substrate 9 to the outside to effect a display by the picture element.

When the protective film which permits an easy elimination of moisture and carbon dioxide is used according to the present invention, the coefficient of secondary electron emission from a protective film can be improved and resultantly the firing voltage of the PDP can be decreased. Further, the emission of impurity gases from the protective film at the time of use is decreased, and a high stability of discharge is obtained.

The protective film for PDP in the present invention is not particularly limited as to the film-forming method so long as the method can give a film of a specific property, namely the specific moisture elimination characteristic, intended by the present invention. There may be used, for example, electron beam vapor deposition, sputtering and ion plating. In order to obtain a film which shows the characteristic property intended by the present invention, however, some contrivance is necessary as an optimization of film-forming conditions suited to respective methods.

The structure required for MgO film which shows the moisture and carbon dioxide elimination characteristics necessary in the present invention is not yet definitely clear.

However, as described above, according to the investigation conducted thus far by the present inventors, the surface structure of MgO and the adsorptive power thereof for moisture and carbon dioxide are related to each other and the (111) plane shows a particularly strong adsorptive power, so that it is advisable to form the film such that other planes than the (111) plane, for example, the (200) plane and (220) plane, are mainly present on the surface.

In the PDP of the present invention, a gas medium is enclosed in the discharge space. Usually, a mixture of rare gas elements is used as the gas medium. More specifically, at least one gas selected from the group consisting of helium, neon, argon, xenon and krypton is used.

The pressure of the enclosed gas is not particularly limited but is preferably 400-760 Torr.

Next, an example, in which the protective film for PDP electrodes according to the present invention is formed by ion plating, is described below.

In the present example, the protective film 5 was formed by using a vacuum film-forming apparatus of ion plating system in which a starting material for film, vaporized by electron beam irradiation, passes through a high frequency coil and deposits on a substrate.

Granular magnesium oxide was used as the starting material for film, oxygen gas was fed into the vacuum film-forming apparatus, and a protective film 5 comprising magnesium oxide was formed. Various film different in properties were formed by varying a heating temperature of the substrate in the film formation and the amount of fed oxygen gas. Further, as a Comparable Example, a protective film was formed also by electron beam vapor deposition method.

The emission characteristics of moisture and carbon dioxide from the film were determined by the TPD-MS (Temperature Program Desorption Mass Spectrometry) method. This method comprises, while heating a sample to increase its temperature at a constant rate, detecting generated gases with a mass spectrometer.

### EXAMPLES

### Examples 1-5

Examples of a process for forming a protective film are described in detail below. Oxygen gas at a pressure of 3×10⁻² Pa was introduced into the vacuum film-forming apparatus and glass substrates were heated at respective temperatures of 100° C., 150° C., 200° C., 250° C. and 300° C. with a substrate heater to effect a film formation, whereby protective films 1, 2, 3, 4 and 5 of Examples were obtained. The film-forming rate was 2 nm/sec.

A high frequency wave of 1.5 kW was applied to the high frequency coil. A voltage of from 100 kV to 400 kV as minus DC bias voltage was applied to the substrate.

The results of determination by the TPD-MS method showed that the main peaks of moisture elimination from the protective films of Examples 1-5 were at 310° C., 314° C., 320° C., 325° C. and 330° C. respectively. It was confirmed that when the films were held at 350° C. for 30 minutes, 90% or more of moisture was eliminated from all of the films.

It was further confirmed that the elimination peak of carbon dioxide was at about 340° C. for all of the films, and 90% or more of carbon dioxide was eliminated when the films were held at 350° C. for 30 minutes.

### Comparative Examples 1-3

Protective films of Comparative Examples 1-3 were formed by electron beam vapor deposition. Oxygen gas was introduced at a pressure of 2×10⁻² Pa and glass substrates were heated to substrate temperatures of 100° C., 200° C. and 300° C., respectively, to effect a film formation, whereby protective films 1, 2 and 3 of Compartive Examples were obtained. The film-forming rate was 2 nm/sec.

The results of determination by the TPD-MS method showed that the elimination of moisture from the protective films 1, 2 and 3 of Comparative Examples had a big peak at about 450° C. besides the peak at about 320° C. in all of the films. It was revealed further that the adsorbed moisture could not be removed completely even when the films were held at 350° C. for 30 minutes, and about 20% of the total adsorbed moisture was left remaining. The elimination peak of carbon dioxide was found at about 340° C. for all of the films.

The secondary electron emission coefficient, which is a parameter closely related to the discharge characteristics of PDP, was determined as follows.

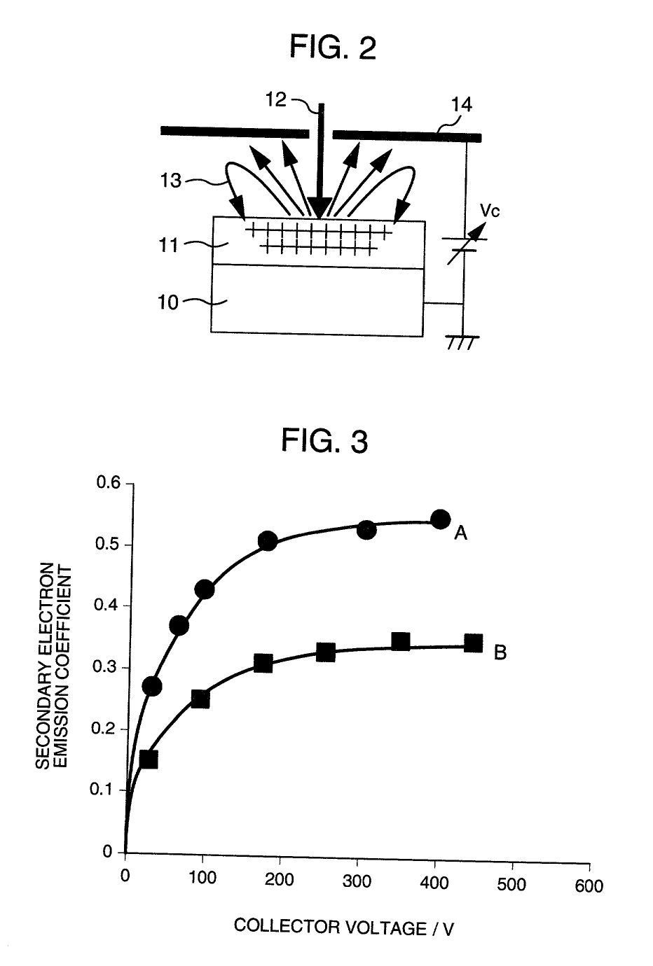

FIG. 2 is a schematic view showing the structure of a secondary electron emission coefficient measuring apparatus used for the determination. With reference to the secondary electron emission coefficient measuring apparatus, as shown in FIG. 2, the surface of a protective film 11 comprising MgO formed on a stainless steel substrate 10 was irradiated with Ne ion beam 12 to emit secondary electrons 13, which were collected by a collector electrode 14 arranged on the upper surface of the protective film 11 to produce an electric current in the electrode 14, and the secondary electron emission yield was determined from the value of the current thus produced.

A bias voltage Vc was impressed between the collector electrode 14 and the stainless steel substrate 10 so as to make the collector electrode 14 the positive electrode so that all of the secondary electrons 13 emitted from the protective film 11 of MgO might be collected. The secondary electron emission coefficient refers to a value which has reached saturation as the voltage Vc applied to the collector electrode 14 is increased.

In determining the secondary electron emission coefficient, Ne ion beam was irradiated with an acceleration energy of 500 eV.

FIG. 3 is a graph showing one example of the results of the above-mentioned determination and shows a collector voltage dependency of the secondary electron emission coefficient.

In FIG. 3, curve A shows the characteristic of the protective film 1 of Example and curve B shows the characteristic of the protective film 1 of Comparative Example. In the Figure, the abscissa stands for the collector voltage and the ordinate stands for the secondary electron emission coefficient (γ).

FIG. 3 reveals that the secondary electron emission coefficient (γ) of the protective film 1 of Example is 0.54, whereas that of the protective film 1 of Comparative Example is a 0.34, the secondary electron emission coefficient of Example 1 being much higher than that of Comparative Example 1.

The secondary electron emission coefficients of the protective films of Examples 2, 3, 4 and 5 were all in the range of 0.5 to 0.6, whereas those of the films of Comparative Examples 2 and 3 were 0.33 and 0.31, respectively.

It can be seen from the results described above that the MgO films of the present Examples, which permit an easy elimination of moisture at low temperature, have markedly larger secondary electron emission coefficients than the MgO films of Comparative Examples, which permit an elimination with more difficulty. The use of a protective film having a large secondary electron emission coefficient can decrease a firing voltage of a PDP.

Effects of the Invention

The use of the protective film of the present invention as a protective film of an AC-type PDP provides an effect that the secondary electron emission coefficient can be made larger and further an excellent effect that evacuation conditions at the time of panel assembling can be made simpler.

What is claimed is:

1. A plasma display panel which has a front substrate having sustaining electrodes wired thereon and a rear substrate having address electrodes wired thereon and displays an image by means of electric discharge that occurs in a minute discharge space formed in a gap between the two substrates and which has a protective film comprising at least one metal oxide which covers a dielectric layer provided to the front substrate, the protective film being constituted essentially of a material which undergoes an elimination of a major part of moisture and carbon dioxide adsorbed thereonto at a temperature of 350° C. or less.

2. A plasma display panel which has a front substrate having sustaining electrodes wired thereon and a rear substrate having address electrodes wired thereon and displays an image by means of electric discharge that occurs in a minute discharge space formed in a gap between the two substrates and which has a protective film comprising at least one metal oxide which covers a dielectric layer provided to the front substrate, the protective film being constituted essentially of a material which undergoes an elimination of 90% or more of moisture and carbon dioxide adsorbed thereonto by heat evacuation having a temperature of 350° C. or less.

3. A plasma display panel which has a front substrate having sustaining electrodes wired thereon and a rear substrate having address electrodes wired thereon and displays an image by means of electric discharge that occurs in a minute discharge space formed in a gap between the two substrates and which has a protective film comprising at least one metal oxide which covers a dielectric layer provided to the front substrate, the protective film being constituted essentially of a material in which a crystal orientation of the film in a direction parallel to the substrate surface consists mainly of the (111) plane and a plane exposed to the surface is mainly the (200) plane and the (220) plane.

4. The plasma display panel according to claim 1, 2 or 3 wherein the protective film comprises at least one oxide comprising magnesium oxide as a main component.

5. The plasma display panel according to claim 4 wherein the protective film comprises magnesium oxide as a main component and additionally at least one oxide of an element selected from the group consisting of Ca, Sr, Ba, Zn, Al, Zr, Si, Ti, Sn, Ce and La.
